(19) United States
(12) Patent Application Publication
(10) Pub. No.: US 2004/0268214 A1
(43) Pub. Date: Dec. 30, 2004

(54) Transaction monitoring system

(76) Inventors: Gabriele Zinssmeister, Tuebingen (DE); Christel Baechleblum, Unterkirmach (DE); Martin Trostel, Tuebingen (DE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/490,297

(22) PCT Filed: Oct. 1, 2001
(86) PCT No.: PCT/US01/30747

(51) Int. Cl. G06F 17/00

(52) U.S. Cl. 715/500

(57) ABSTRACT

An export management system includes a store of information about pending transactions, and a computer. The transactions have already been evaluated with respect to a set of constraints (e.g., export regulations). The computer is programmed to automatically re-evaluate the transactions when any constraints on the transactions are changed.

Other aspects and advantages of the present invention will become apparent from the following detailed description, taken in conjunction with the accompanying drawings, illustrating by way of example the principles of the present invention.

### BACKGROUND OF THE INVENTION

Many countries issue regulations on international trade. For instance, the United States issues Export Administra-tion Regulations (EAR) relating to the control of certain exports, re-exports, and activities. The export control provisions of the EAR are intended to serve national security, foreign policy, nonproliferation, and short supply interests of the United States and, in some cases, to carry out its international obligations. Some controls are designed to restrict access to dual use items by countries or persons that might apply such items to uses inimical to U.S. interests. These include controls designed to stem the proliferation of weapons of mass destruction and controls de-signed to limit the military and terrorism support capability of certain countries. The effectiveness of many of the controls under the EAR is enhanced by their being maintained as part of multilateral control arrangements. Multilateral export control cooperation is sought through arrangements such as the Nuclear Suppliers Group, the Australia Group, and the Missile Technology Control Regime. The EAR also include some export controls to protect the United States from the adverse impact of the unrestricted export of commodities in short supply.

The EAR may require a license to a country if a product is listed on the Commerce Control List (CCL) and if a Country Chart (specified in the EAR) indicates that a license is required to that country. Virtually all Export Con-trol Classification Numbers (ECCN) on the CCL are covered by the Country Chart. These ECCNs state the specific countries that require a license.

Large companies usually maintain staffs of administrators to ensure compliance with export control laws. Before a product can be exported, an administrator must determine whether an export license is needed, whether one is already in place, whether additional assurances are needed, whether the export is prohibited, etc. Making this determination is slow and manually intensive, especially for a company that sells a large number and variety of products to many different countries. Not only does this determination involve U.S. laws, but it usually involves local exporting country laws as well.

### SUMMARY OF THE INVENTION

An export management system includes a store of information about pending transactions, and a computer. The transactions have already been evaluated with respect to a set of constraints (e.g., export regulations). The computer is programmed to automatically re-evaluate the transactions when any constraints on the transactions are changed.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an illustration of an export license determination server.

FIG. 2 is an illustration of events and corresponding responses by the server.

FIG. 3 is an illustration of an exemplary license determination table for the server.

FIG. 4 is an illustration of an order management system.

### DETAILED DESCRIPTION OF THE PREFERRED EMBODIMENTS

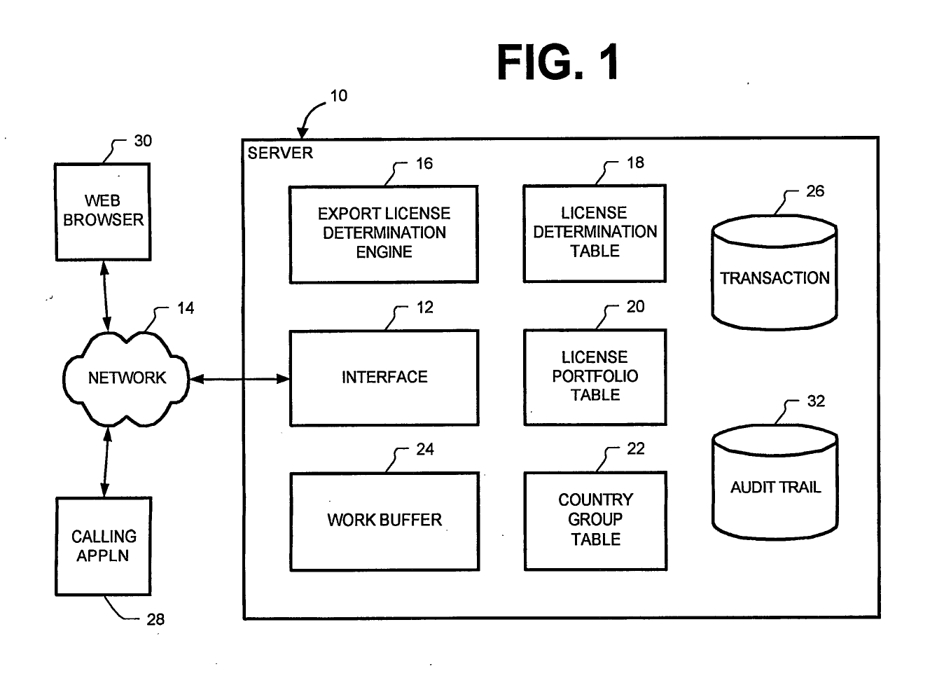

Reference is made to FIG. 1, which illustrates an export license determination server 10. The server 10 includes a network interface 12 that is connected to a network 14. There is no limitation as to the type of network 14. For example, the network 14 can be a corporate intranet or the Internet.

The server 10 provides an export license determination engine 16, a license determination table 18, a license portfolio table 20, and a country group table 22. The network interface 12 receives information about pending transactions via the network 14, and passes the information to the engine 16. The engine 16 uses the tables 18, 20 and 22 to make an export license determination with respect to the transaction.

The pending transaction might be the sale of a product to a destination country. The transaction information may include a destination country. The server 10 uses the country group table 22 to determine a country group for the destination country. A country group may include one or more countries.

The transaction information may also include either a product classification group or a product identifier (which allows the classification group to be ascertained). The classification group may be supplied directly to the server 10. In the alternative the server 10 may send a product identifier to another program, which ascertains the classification group. One such program is disclosed in U.S. Serial No. ______ filed concurrently herewith (Attorney Docket No. 10012302-1). A classification group may be an ECCN or any other designation.

The license determination table 18 includes a series of cells. Each cell indicates a license determination for a particular country group and classification group. A license determination might indicate that a license is not needed, a license is needed but is already in place, manual work is needed (e.g., a license is needed and must be executed, additional assurances are needed to comply with controlling export laws), a transaction is not allowed, etc.

If the license determination indicates that no manual work is needed (that is, the transaction complies with all export regulations), details of the transaction may be stored in a transaction data database 26. If the license determination indicates that further work is needed, details of the transaction may be stored in a work buffer 24. The transaction may remain in the work buffer 24 until another event occurs. As a first example, the transaction may remain in the work buffer 24 until additional manual work brings the transaction into compliance with all export regulations (e.g., an export license is executed). Once the transaction is brought into compliance, it is moved from the work buffer 24 to the transaction data database 26. As a second example, the transaction is deleted from the work buffer 24 if the transaction is cancelled.

The license determination table 18 may be generated by a select group of export administration personnel, and it may be stored in a central location, so that only one table is used by the export license determination engine 16. Centralized decision-making should lead to consistent determinations. Because the export license determination engine 16 is table-driven, the license determinations may be updated (e.g., due to changes in laws, addition of new licenses, lapsing of old licenses) without rewriting the engine 16 or the interface 12.

The license portfolio table 20 stores electronic versions of export licenses that are referenced by the license determination table 18.

There may be one or more license determination tables 18, and there may be one or more license portfolio tables 20. There may be different tables 18 and 20 for different exporting countries.

The server 10 may be implemented in any number of ways. For example, the server 10 may be a part of a larger enterprise system, which includes network-attached storage (NAS) devices or other storage machines. The license determination table 18, the license portfolio table 20 and the country group table 22 (as well as the work buffer 24, the transaction data database 26 and an audit trail database 32 mentioned below) may be stored in the NAS devices or the other storage machines. The server 10 may be a single computer or it may be run as a distributed logic/data system having several computers.

Other transaction information supplied to the server 10 might include ship-to-address, ship-from-address, contract party, and deliver-to-address. This information may be used for audit and legal reporting purposes. This information also facilitates manual follow-ups whenever necessary (as in the case of individual validated licenses).

The transaction information may be supplied by any client 28, 30 that can connect to the server 10. The clients may be personal computers and workstations that are connected to the server 10 via the network 14. Certain clients could include calling applications 28 (e.g., other software applications that make requests for license determinations). In the alternative, calling applications may be integrated with the server 10.

Clients could include web browsers 30 that allow individuals to request license determinations. For example, the interface 12 may include XML files that are downloaded and displayed by the web browsers 30. The XML files would allow the web browsers 30 to enter the transaction information. The web browsers 30 may also display the license determinations and licenses stored in the license portfolio table 20.

The web browser 30 also allows export administration personnel to access the server 10. Certain export administration personnel may be authorized to update the tables 18-22. Others personnel may be authorized to check their portion of the work buffer 24 to determine which transactions need manual attention.

The server 10 may perform functions other than making license determinations. When a transaction is shipped, details of the transaction may be moved from the transaction date database 26 to the audit trail database 32.

The server 10 offers broad connectivity to multiple client platforms by web-based, standard interface. If the server 10 is on-line 24 hours a day, license determinations and related services may be requested at any time.

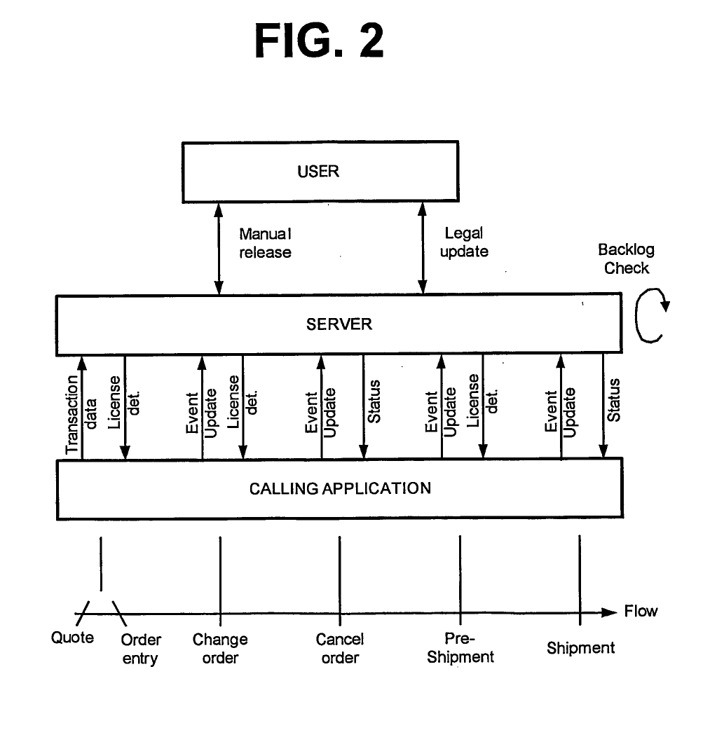

FIG. 2 shows a number of events, and actions taken by the server 10 in response to the events. The events include (1) quote, (2) order entry, (3) change order, (4) cancel order, (5) pre-shipment, (6) shipment, (7) backlog check, (8) manual release, and (9) legal update. The first six events are initiated by calling applications. When a quote or order entry is placed, a calling application supplies transaction data to the server 10. In response, the server 10 makes an export license determination and notifies the calling application of the license determination. If “hold” is the export license determination, details of the order are stored in the work buffer 24. If “okay” is the determination the details of the order are placed in the transaction data database 26.

Shortly before an order is shipped, a calling application requests the server 10 to perform a clearance check, to ensure that the order still complies with export regulations. The server 10, which already has the transaction data, returns a license determination. If “okay” is the determination, the shipment is allowed to proceed.

When the order is shipped, a calling application informs the server of this event, and the server 10 returns a status to the calling application. The server 10 also causes the details of the order to be moved from the transaction date database 26 to the audit trail database 32.

Usually an order is not shipped immediately after it is placed. Time will elapse. During that time, the order might be changed, or it might be cancelled. If the order is cancelled, a calling application informs the server 10 of this event. In response, the server 10 permanently removes the transaction details of the cancelled order from the work buffer 24 or the transaction data database 26. The server 10 also informs the calling application of the actions taken (status).

If the order is changed, a calling application informs the server 10 of this event. In response, the server 10 re-evaluates the order for compliance with export regulations. That is, an export license determination is performed on the changed order. The server 10 also informs the calling application of the actions taken.

The seventh event, the backlog check, is internal to the server 10. The server 10 may schedule the backlog check periodically (e.g., once a day). During a backlog check, export license determinations for all transactions in the work buffer 24 and the transaction data database 26 are performed. Instead of waiting for the backlog check to be performed at its scheduled time, the backlog may be checked immediately by initiating a manual release (the eighth event).

The eighth and ninth events (legal update) are initiated by a user such as an export administrator. If an export regulation is changed, the user causes the server 10 to perform an export license determination on each order in the work buffer 24 and the transaction data database 26. A legal update would occur, for example, if a country is moved to a list of embargoed countries. For any pending transactions concerning the newly embargoed country, transaction details would be moved from the transaction data database 26 to the work buffer 24.

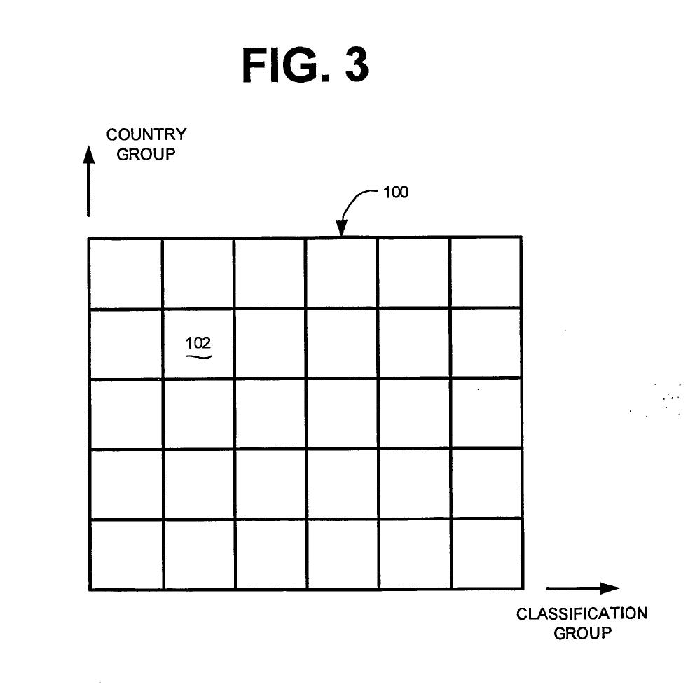

FIG. 3 shows one way in which the license determination table 18 may be organized: as a matrix 100. Country groups extend along one axis, and the classification groups extend along the other axis. Each cell 102 of the matrix 100 contains license information. Each row corresponds to a single country group and contains different license determinations for different classification groups. For example, one row might correspond to a group of embargoed countries. Each column corresponds to a single classification group and contains different license determinations for different country groups.

For example, one cell 102 might indicate that a license is not needed for the corresponding country group and classification. The license determination for that country group would be “NLR” (no license required).

Another cell 102 might indicate that a license is already in place for a given country group and classification group. The server 10 will then check the license portfolio table 20 to determine whether an actual license is available and its parameters match the given transactions. If the parameters match, the license determination for that country group and classification will be “okay.” If there is no match, the license determination for that country group and classification will be “hold” and the transaction will be placed in the work buffer 24 until further action is taken (e.g. applying for and adding the actual license into the license portfolio table 20).

Another cell 102 might indicate that a license is in place, but the product could be used for military as well as civilian purposes. The license determination for that country and product would be “hold,” and the transaction would be placed in the work buffer 24 until further action was taken (e.g., ensuring that the product would be used for civilian use only). It might also indicate the country in which the additional work is needed.

The matrix 100 shown in FIG. 3 contains thirty cells 102. In practice, any number of cells 102 may be used.

The present invention can be extended beyond an export license determination system. The export license determination system may be part of a larger system, such as an export management system. Such an export management system may include a computer and a store of information about pending transactions. The transactions have already been evaluated with respect to a set of constraints (e.g., export regulations). The computer is programmed to automatically re-evaluate the transactions when any constraints on the transactions have changed.

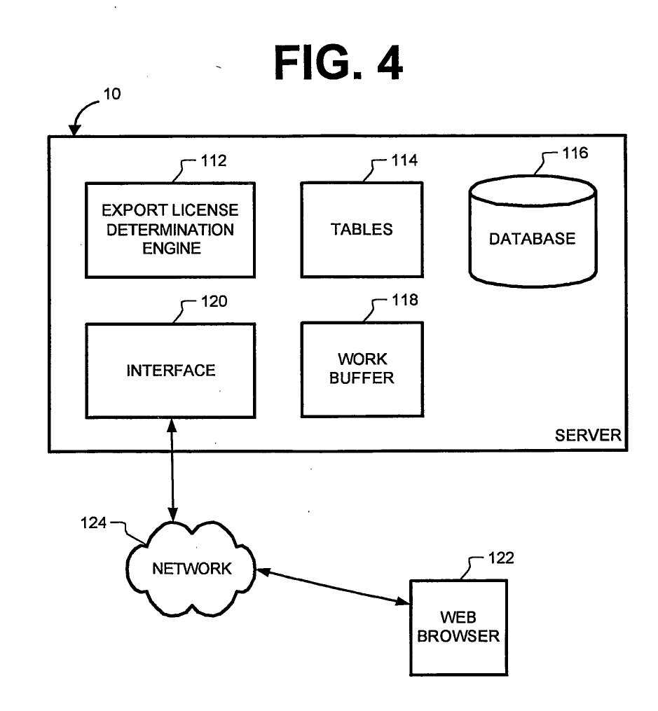

Reference is now made to FIG. 4, which shows an exemplary export management system 110. The export management system 110 may include tables 114 and a table-driven engine 112 for performing various legal determinations, among which are export control license determinations (e.g., license check, customer check). Other determinations might include duty and tax information (e.g., calculating duty rates and duty amounts, calculating tax rates and tax amounts). The export management system 110 can re-evaluate any determinations that are affected by changes in regulations or other constraints. For instance, duties could be re-computed if rates or classifications are changed. The system 110 may perform other functions, such as paying additional duties, applying for a refund, or filing a tax statement. A re-evaluation also may be performed when a relevant transaction parameter is changed (e.g., shipment destination country).

The export management system 110 further includes various stores, including databases (e.g., transaction data databases, audit trail databases) 116 and a work buffer 118. A network interface 120 connects to a network 122 and allows clients (e.g., web browsers, calling applications) 124 to request information from the system 110 and interact with the tables 114 and the work buffer 118.

Although specific embodiments of the present invention have been described and illustrated, the present invention is not limited to the specific forms or arrangements of parts so described and illustrated. Instead, the present invention is construed according to the claims the follow.

What is claimed is:

1. An export management system comprising a store of information about pending transactions, the transactions having already been evaluated with respect to a set of constraints; and a computer programmed to automatically re-evaluate the transactions when any constraints on the transactions are changed.

2. The system of claim 1, wherein the constraints are legal constraints.

3. The system of claim 2, wherein the legal constraints are export regulations.

4. The system of claim 2, further comprising a store for text of the legal constraints.

5. The system of claim 1, wherein the store is a database containing information about transactions awaiting shipment.

6. The system of claim 1, wherein the store is a work buffer containing information about transactions under attention.

7. The system of claim 1, wherein the computer is further programmed to re-evaluate transactions for which a parameter has changed.

8. The system of claim 1, wherein the computer is further programmed to perform clearance checks.

9. Export license determination apparatus comprising: a database of information about pending transactions, the transactions having already been evaluated for compliance with a set of export regulations; and an engine for automatically re-evaluating the transactions when any constraints on the transactions are changed.

10. The apparatus of claim 9, wherein the database also stores text of the export license regulations.

11. The apparatus of claim 9, wherein the database stores information about transactions awaiting shipment.

12. The apparatus of claim 9, further comprising a work buffer containing information about transactions needing manual review.

13. The apparatus of claim 9, wherein the engine also re-evaluates transactions for which parameters have changed.

14. The apparatus of claim 9, wherein the engine also performs clearance checks.
